(19) United States
(12) Patent Application Publication
(10) Pub. No.: US 2004/0076127 A1
(43) Pub. Date: Apr. 22, 2004

(54) Handling of wireless communications

(76) Inventor: David John Porte, Harvard, MA (US)

Correspondence Address: DAVID L. FEIGENBAUM, Fish & Richardson P.C., 225 Franklin Street, Boston, MA, 02110-2804, US

(21) Appl. No.: 10/273,522

(22) Filed: Oct. 18, 2002

(51) Int. Cl. H04Q 7/00

(52) U.S. Cl. 370/328; 370/400; 370/466

(57) ABSTRACT

A wireless communication signal is received from an antenna at a site. Packets (or other signals) that contain communication information are derived from the wireless communication signal, each of the packets (or other signals) containing routing information sufficient to enable routing of the packet (or other signal) to a processor capable of providing communication processing services suitable for the wireless communication signal. The packets (or other signals) are routed through a network to a processor not located at the site and that is capable of providing communication processing services suitable for the wireless signal.

### BACKGROUND

This description relates to handling of wireless communications.

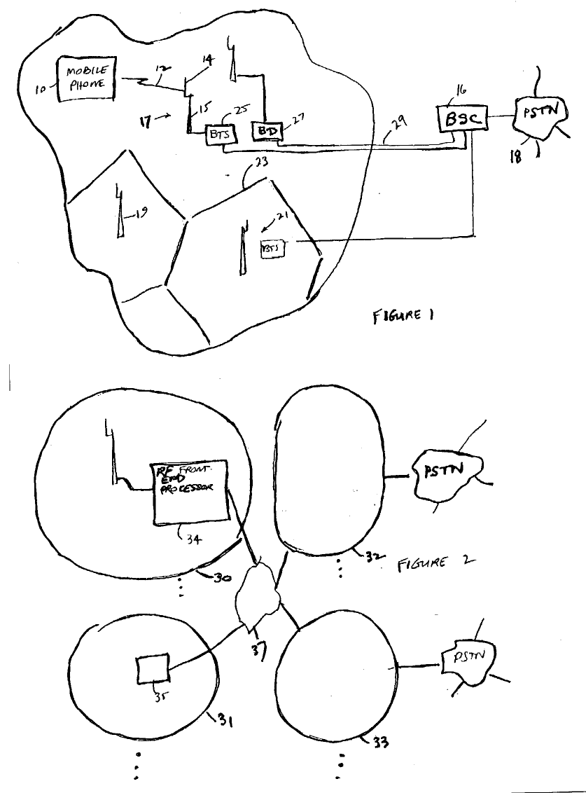

As shown in FIG. 1, during a typical mobile telephone call, a mobile phone 10 uses a modulated radio frequency (RF) wireless link 12 to communicate with a stationary antenna 14 mounted on an antenna tower 15 at a tower site 17 that is within RF communication range of the mobile phone. Many tower sites 17, 19, 21 (only three sites are shown in the figure) are provided at more or less closely spaced locations in a geographic region to be served, as required by the expected volume of mobile phone calls, the expected number of users, and the radio frequency energy needed to support the calls. As a user moves out of one cell and into a second cell 23, the call is handed off to another tower site (e.g., site 21) that serves the second cell.

The call information that is carried on the modulated RF signal is usually a bitstream of digital information that includes the content of the call (the voice information for a voice call or the data for a data session; for simplicity we will use the term call to refer to either a voice call or a data session or any other form of a communication between parties) and control information that enables the mobile phone, the base station, and other equipment to process the call and route it appropriately. The content and control information are encoded in the digital stream in accordance with a predefined protocol, such as GSM, TDMA (IS-136), or CDMA (IS-95). The control information carries information, such as power level, network identification, and call status, among other things, between the terminal device (e.g., the mobile phone) and non-mobile call processing devices. Signals that are received and sent at the antenna are handled at the tower site by a corresponding base station 25 (also called a base transceiver station or BTS) that is normally owned by the same carrier that owns the associated antenna. The base station is configured to handle a particular protocol and frequency band being used at that antenna. The base station acts as a modulator and demodulator of the call between the carrier RF frequency and the baseband bitstream of digital information, acts as a coder and decoder of the information carried in the baseband stream, and performs certain call processing functions, such as power control, hand-off control, and content decoding, among other things.

For an incoming call, the base station demodulates the radio frequency signal down to the baseband (i.e., the bitstream) and then decodes the bits of the baseband signal to derive a stream of symbols that represent the content and the control information in accordance with the protocol. The base station uses the decoded content and control symbols to process the call and forwards the decoded content symbols and, in some cases, some of the control symbols, to a centrally located base station controller (BSC) 16 using a back haul circuit 29 (wire, microwave, or optical fiber). Typically the decoded content symbols are carried in a compressed form that results from compression based on digital sampling rates and elimination of dead time. The base station controller is usually owned and maintained by the same wireless service provider that owns the antennas and the base stations that the controller serves. A base station controller controls each of a number of the provider's base stations 25, 27 located at different tower sites. The base station controller normally is connected directly to each of the base stations under its control, forming a star-type network. None of the base stations can communicate directly with any other base station. The main function of the base station controller is to handle handoff between cells and to route calls to and from, for example, a switch connected to the public switched telephone network, for connection to the destination station.

Communication on the wireless link provided by each antenna typically occurs within a portion of a segment of a predetermined frequency band of the telecommunications spectrum, for example, within a 1.25 MHz portion of a 15 MHz segment of a communication band at 1.9 GHz. The specific 15 MHz segment is a segment owned by the carrier, and the portion of the segment is typically allocated by the carrier to a site and an antenna in a fixed manner that is based on the peak volume of calls that the carrier expects to handle at the site. The carrier may allocate other portions of the 15 MHz segment to other sites served by the carrier or, for example, may allocate the entire 15 MHz segment to all sites. The number of calls that can be handled at a given time from a particular site depends in part on the size of the portion of the segment of the communication band that is allocated to the site, on the capability of the base station and other equipment located at the site, and on the strength of the RF signal relative to the amount of interference.

The architecture shown in FIG. 1 with respect to a small number of sites (carrier-owned antennas and base stations dedicated to particular frequencies and particular protocols and carrier-owned base station controllers that serve multiple base stations) is replicated hundreds or thousands of times around the country with respect to multiple carriers, multiple frequencies owned by each carrier, protocols offered by each carrier, and multiple sites served by each of the carriers using each of the protocols and frequencies. Sometimes, each carrier also owns the tower that supports the antenna, the land on which it is built, and a shelter for the base station. Frequently, multiple providers share the tower and the land to reduce their costs.

Base stations, base station controllers, and antennas are expensive to buy and to maintain. As each carrier's wireless system grows geographically and in numbers of users, the carrier must buy and maintain additional antennas and base stations in numbers that are roughly proportional to the number of additional users. Each carrier bears both the initial capital cost and the ongoing maintenance cost associated with its wireless system. As new communication protocols and new frequency bands are developed and offered to users, each carrier, to remain competitive, adds base stations and antennas to comply with the new technologies. Providing higher bandwidth links at antennas to carry data and multimedia information also requires additional capital and maintenance expenditures by each carrier.

Some carriers handle multiple frequency bands using a single wide-band antenna or an array of antennas or a smart antenna for which the frequency and level of power can be controlled dynamically. Multi-band power amplifiers may also be provided in a base station to handle different frequency bands.

### SUMMARY

In general, in one aspect, the invention features receiving a wireless communication signal from an antenna at a site, forming packets (or other signals) that contain communication information derived from the wireless communication signal, each of the packets (or other signals) containing routing information sufficient to enable routing of the packet (or other signal) to a processor capable of providing communication processing services suitable for the wireless communication signal, and routing the packets (or other signals) through a network to a processor not located at the site and that is capable of providing communication processing services suitable for the wireless signal.

In general, in another aspect, the invention features receiving a wireless communication signal at a communication processing facility, forming packets that contain communication information derived from the wireless communication signal, each of the packets containing routing information sufficient to enable routing of the packet to a site suitable to transmit the communication information wirelessly to a mobile station, and routing the packets through a network to a site not located at the communication processing facility and that is suitable to transmit the communication information to the mobile station.

Implementations of the invention may include one or more of the following features. The communication signal comprises a telephone call signal. Forming the packets includes embedding routing information in a header of each of at least some of the packets. The routing information includes an identification of a carrier associated with the wireless communication signal. The routing information includes an identification of a protocol used for the wireless communication signal. The routing information includes an identification of a spectrum range used for the wireless communication signal. The routing information includes an identification of a location of the site. The packets contain content information and control information associated with the wireless communication signal. The control information is compressed before routing. The content information is compressed before routing. The control information is usable by the processor to provide call processing services with respect to the call signal. The packets are formed and routed without fully decoding the wireless communication signal. Symbols carried in the wireless communication signal are partially decoded to derive at least some of the identification information. The method also may include receiving other wireless communication signals at the site, forming other packets that contain communication information derived from the other wireless communication signals, each of the packets containing routing information sufficient to enable routing of the packet to a processor capable of providing communication processing services suitable for the wireless communication signal, and routing the other packets through a network to processors not located at the site and that are suitable to provide communication processing services suitable for the wireless signals. The method also may include receiving other wireless communication signals at the communication processing facility, forming other packets that contain communication information derived from the other wireless communication signals, each of the packets containing routing information sufficient to enable routing of the packet to a site suitable to transmit the communication information wirelessly to a mobile station, and routing the other packets through a network to sites not located at the communication processing facility and that are suitable to transmit the communication information to the mobile stations. The method may also include receiving other wireless communication signals at other sites, forming other packets that contain communication information derived from the other wireless communication signals, each of the packets containing routing information sufficient to enable routing of the packet to a processor capable of providing communication processing services suitable for the wireless communication signal, and routing the other packets through a network to processors not located at the sites and that are suitable to provide communication processing services suitable for the wireless signals. The method may also include receiving other wireless communication signals at other communication processing facilities, forming packets that contain communication information derived from the other wireless communication signals, each of the packets containing routing information sufficient to enable routing of the packets to sites suitable to transmit the communication information wirelessly to mobile stations, and routing the packets through a network to sites not located at the communication processing facilities and that are suitable to transmit the communication information to the mobile station.

In general, in another aspect, the invention features receiving wireless communication signals at geographically distributed sites, and routing the wireless communication signals from the sites through a packet-based or switched communication network to processors configured to perform communication processing operations on the wireless communication signals.

In general, in another aspect, the invention features receiving wireless communication signals at communication processing facilities, and routing the wireless communication signals from the communication processing facilities through a packet-based or switched communication network to sites capable of transmitting the wireless communication signals wirelessly to mobile stations.

Implementations of the invention may include one or more of the following features. The communication signals comprise telephone call signals. Wireless communication signals are routed based on identification information. The identification information includes an identification of a carrier associated with the wireless communication signal. The identification information includes an identification of a protocol used for the wireless communication signal. The identification information includes an identification of a spectrum range used for the wireless communication signal. The identification information includes an identification of a location of the site. The signals contain content information and control information associated with the wireless communication signal. The control information is compressed before routing. The content information is compressed before routing. The control information is usable by the processor to provide call processing services with respect to the call signal. The wireless communication signals are routed without fully decoding the wireless communication signal. The method may also include partially decoding symbols carried in the wireless communication signal to derive at least some of the identification information.

In general, in another aspect, the invention features receiving wireless communication signals at geographically distributed sites, and performing base station processing on the wireless communication signals in at least one location remote from the sites.

Implementations of the invention may include one or more of the following features. The method may also include performing base station control functions with respect to the wireless communication signals in at least one location remote from the sites. The base station processing is performed by devices that are interconnected by a network processing of wireless communication calls is allocated among the devices to balance load.

In general, in another aspect, the invention features receiving wireless communication signals at sites, each of the wireless communication signals conforming to a predetermined wireless communication protocol, routing the wireless communication signals to devices separated from the sites for wireless communication processing, and forwarding the wireless communication signals through a public switched network to destinations, at least some of the wireless communication signals being converted by the devices to protocols other than the predetermined protocols prior to being forwarded to destinations.

In general, in another aspect, the invention features receiving wireless communication signals at a site, without performing complete base station call processing on the received signals at the site, and sending the wireless communication signals to other locations for call processing.

In general, in another aspect, the invention features receiving wireless communication signals at a site, performing partial processing on each of the signals including compression and determination of a carrier with which the signal is associated, and routing each of the signals, after partial processing, to a location separate from the site for communication signal processing in accordance with the determined carrier.

In general, in another aspect, the invention features a medium bearing a data structure capable of invoking routing functions of a network in which a network packet includes information associated with content of a wireless communication signal and routing information sufficient to enable the packet to be routed to a device capable of processing the wireless communication signal.

Implementations of the invention may include one or more of the following features. The routing information includes an identification of a geographic location of a site at which the wireless communication system is being handled. The routing information includes an identification of a service provider that is providing service with respect to the communication signal. The routing information includes an identification of a spectrum range associated with the communication signal.

In general, in another aspect, the invention features an interface to a packet network that serves sites at which wireless communication signals are handled, communication processing equipment configured to process wireless communication signals, and a mechanism to share processing of the wireless communication signals among available equipment of wireless communication processing facilities.

Implementations of the invention may include one or more of the following features. The mechanism comprises a second network. The mechanism comprises load sharing among multiple devices of the call processing facilities.

In general, in another aspect, the invention features sending from a site to a wireless communication processing location that is separate from the site, information about wireless transmission services that are available at the site, accepting at the site, wireless communication signals from the wireless communication processing location, and performing wireless transmission services at the site with respect to the signals.

In general, in another aspect, the invention features at a site that handles wireless communication signals for mobile stations, down converting incoming wireless communication signals to baseband signals, and communicating the baseband signals to a location separate from the site for performance of call processing.

Among the advantages of the invention are one or more of the following. The capital and operating expenses of wireless service providers are reduced significantly because the carriers can share the bulk of the tower site assets of the wireless network as well as some of the central call processing facilities. The processing load for base stations can be balanced and redirected dynamically among base stations as demand and capacity shift. New protocols can be deployed by simple software upgrades that are downloaded to the front-end processor (which we also call a spectrum router) located at the tower site. Capacity can be scaled smoothly with demand and the need for large up-front investments in tower site equipment is reduced. Wireless carriers can lease or arbitrage spectrum (that is, the available wireless communication capacity at various tower sites) to and from other carriers on a cell-by-cell and hour-by-hour basis, thus improving the value of the spectrum and reducing spectrum blockages. A third party may own a spectrum router at tower sites and thus make communication capacity available to carriers at geographic locations that are not readily available to them otherwise, for example, because they do not own antennas or towers or other physical facilities at the sites. Yet each carrier retains full control over its spectrum, traffic, call processing, and design of its wireless network. In some implementations, traffic can be delivered directly to centralized base station controllers, without the need for conventional base stations, further reducing cost.

Other advantages and features will become apparent from the following description and from the claims.

### DESCRIPTION

FIGS. 1, 2, and 3 are block diagrams of portions of wireless communication systems.

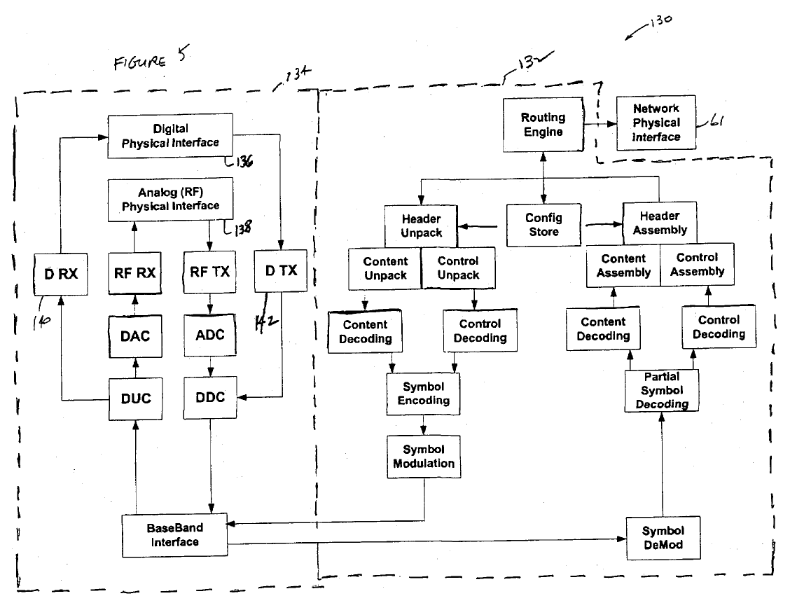

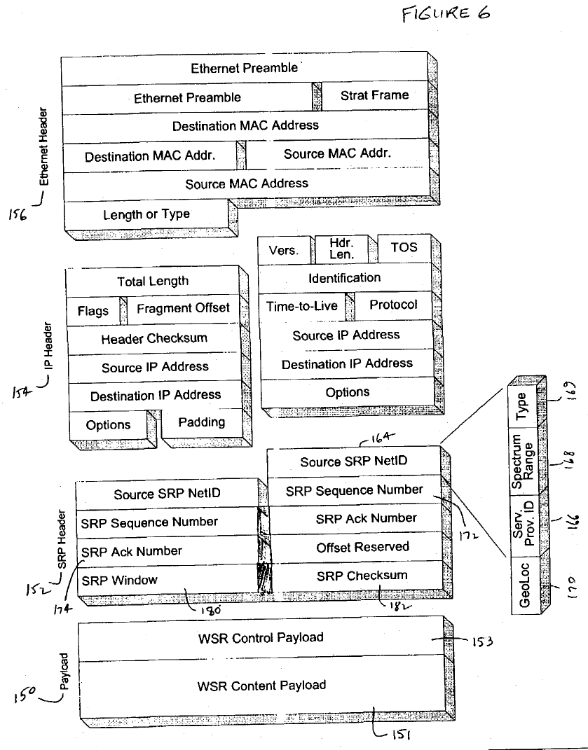

FIGS. 4 and 5 are block diagrams of call processing equipment.

FIG. 6 is a diagram of a packet template.

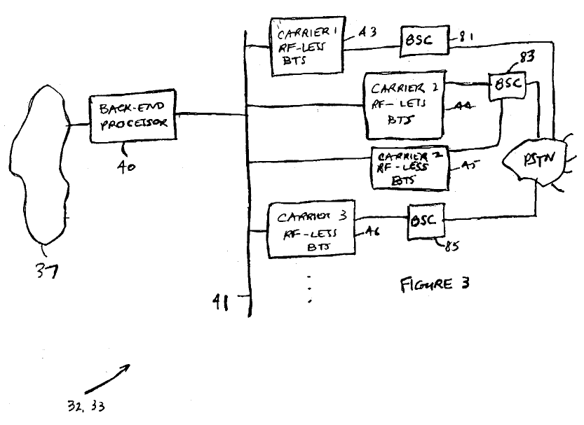

As shown in FIG. 2, by re-locating functions of a base station that are dedicated to a particular protocol, frequency, or carrier, from a tower site 30 to co-location call processing facilities 32, 33, significant advantages can be achieved. (By co-location we mean, for example, that more than one carrier may share equipment and facilities for call processing or that a single carrier may co-locate its call processing, controllers, and switches into a single facility.). To accomplish this, in one example, a RF front-end processor 34, 35 provided at each of the tower sites 30, 31 modulates and demodulates the RF signals, recaptures the symbols that are represented by the bit stream and performs enough decoding and coding of the symbols to permit a determination of the protocol and the carrier for each given call. In some cases, the front-end processor does no more coding or decoding than is minimally required to permit a determination of the protocol and the carrier. In other examples, more coding and decoding could be done. The front-end processor then embeds additional information in the symbol stream to permit routing of the call within a communication network 37 to a device that is configured to process the call. In some examples, network 37 is an IP network that is physically formed, for example, of T1 or DS3 lines or IP-style pipes. The medium could be fiber, microware, coaxial cable, free space optics, or copper pairs, for example. The symbol stream is compressed, packetized, and then routed through the packet switched network 37 to one of the call processing facilities 32, 33, that is expected to be capable of processing the call.

Each call processing facility handles the incoming packets and processes the corresponding calls by performing tasks that include (a) back-end processing that reverses the process performed by the front-end processor at the tower site, and (b) functions of conventional base stations and conventional base station controllers. In some examples, conventional base stations and conventional base station controllers may be part of the equipment at the call processing facilities. In other cases, the equipment can be designed to combine functions of base stations, controllers, and switches, and in that way to reduce the aggregate amount of equipment needed to process the calls. A number of call processor facilities can be established to handle calls in a distributed fashion to enable load balancing and redundancy so that all call symbol streams delivered into network 37 by the front-end processors are handled promptly and efficiently. The output of the back-end processing that occurs at the call processing facility may be either data streams or channelized voice calls which are then delivered to, for example, the public switched telephone network for routing to their destinations or to a data network such as the internet for routing to their destinations.

Because the call processing activities have been moved to centralized call processing facilities, each tower site need not contain any of the dedicated conventional base station that typifies conventional tower site configurations. The scheme of FIG. 2 is thus different from and provides considerable benefits compared to the system of FIG. 1. In the system of FIG. 1, the carrier and protocol of each call is determined and the call signal is processed at the tower site by base stations owned by and configured specially for the carrier that is carrying the call. The output of the base station is a call symbol stream that is custom formed for use by the carrier's dedicated base station controller equipment located at a distance from the site. The call stream must be communicated to the dedicated remote base station controller for further processing. In effect, each of the calls is committed at the base station to dedicated processing by the carrier for the protocol involved. Thus, dedicated equipment and processing capacity must be available at every tower site for every carrier and protocol.

By contrast, in the system of FIG. 2, no call is committed to carrier-dedicated processing at the tower site. Instead, the equipment at the tower site only performs a limited amount of processing necessary to identify the carrier and the protocol and therefore to route the call through a network to remote equipment where the dedicated call processing can be done. In other words, at the tower site, no processing is done any differently on any of the call streams than on any other, with the exception that a determination is made of where the call stream should be sent based on, for example, the carrier or the protocol involved. By its nature, the packet switched network through which the calls are routed from the tower sites can serve and be served by an extensible, distributed set of nodes where the actual call processing is to be done. The network provides fault tolerance for the step of communicating the calls to the processing equipment. If one portion of the network fails, the call can be routed in other ways to reach their destinations. In addition, the calls need not be routed only to specific predetermined nodes for processing. Rather, it is possible to provide dynamically changing, expandable numbers and locations of call processing facilities which can continually advertise their availability on the network to provide call processing services with respect to various carriers and various protocols. The advertised services can be tracked at the tower sites, in typical network fashion, so that at the moment a given call must be routed for processing, the equipment at the tower site can route it to any one of the available nodes. The result is that the load of dealing with calls can be distributed and reallocated dynamically to accommodate any fluctuations that occur in the volume of calls, the carriers, or the protocols being handled at any of the tower sites or any group of them. In addition, any tower site can be configured and reconfigured at any time and remotely to handle calls for any existing carriers and protocols or any new carriers or protocols and for any volume of calls that the antenna and antenna driving equipment are capable of handling.

On the call processing side of the network, any number or combination of back-end processors, base stations, and base station controllers can be provided at any number or combination of nodes. Call processing load can be shifted around the network from node to node in typical network fashion. Call processing capability can be owned, shared, bought and sold, leased, and provided by any combination of carriers or third parties.

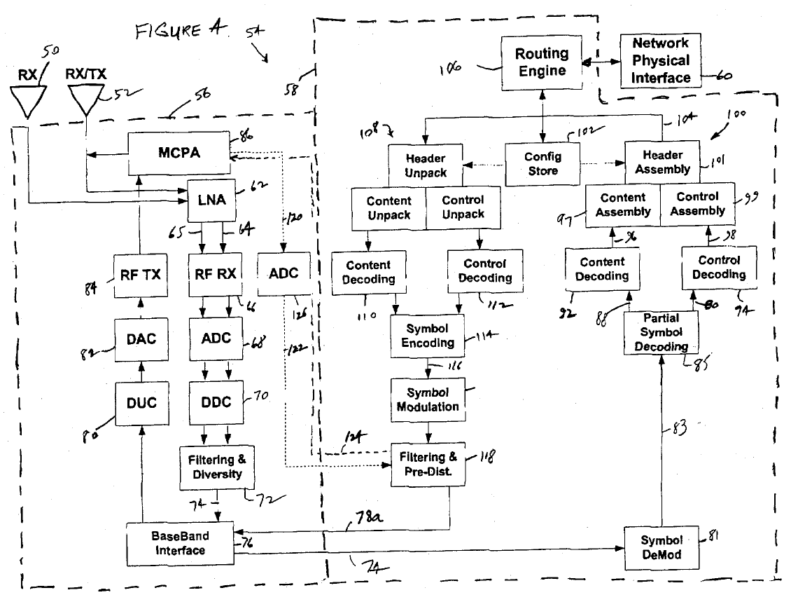

There are various ways to organize and configure each call processing facility. In one approach, shown in FIG. 3, each call processing facility 32, 33 includes a back-end processor 40 (or, in some examples, more than one back-end processor) and an internal network 41 connecting the back-end processor to a set of base stations 43 though 46. The back-end processor receives packets of symbol streams from the front-end processors of one or more sites, de-packetizes the symbols, decompresses the symbol streams, and restores the symbol streams to their raw baseband condition as bitstreams, that is, the condition in which they existed at their original sites just after the demodulation and analog to digital conversion that removed the RF carriers. The output of the back-end processor 40 could be either a digital signal or an analog RF signal depending on the interface available on base station components of the call processing facility. The back-end processor 40 then routes the stream either by direct connection (in an implementation not shown in the figure) or through a local area network 41 to an RF-less base station 43, 44, 45, 46 that is associated with the appropriate carrier and is capable of handling the protocol in which the call is encoded. Each of the RF-less base stations then processes the call in essentially the same fashion that would have occurred with respect to the raw demodulated bitstream at the tower site. The base stations 43, 44, 45, 46 may be owned by the carriers or leased by them from another party or shared in common, for example. The base stations are in turn connected to base station controllers 81, 83, 85, which in some examples operate in the same fashion as known base station controllers. The base station controllers may be owned by respective carriers and dedicated to that carrier's base stations or could be leased or could be shared in common with other carriers. In some cases, the back end processor may not be a separate piece of equipment but may be a physical or logical component of the call processing equipment.

The use of a local area network to connect the BTSs in the example shown in FIG. 3 enables simple and efficient scaling of the call processing capabilities to meet demand, and also enables simple load balancing.

The back end processor, the base stations, and the base station controllers could all be located in a single place. Alternatively, each of those kinds of devices or pairs of them could be located separately from the others. For example, the base station controllers could be located separately from the place where the back-end processor and base stations are located. In operation, call signals being handled at different antennas of tower sites are pre-processed by the front end processors, then forwarded through network 37 to any one of the back-end processors that happens to be available and is known to be associated with a call processing facility capable of handling the carrier and the protocol of the call.

The front end processor knows which back end processor or processors to send the information to based on the routing tables contained in the routers. In some implementations more than one back end processor can be available for parallel processing of call information, in effect a farm of distributed back-end processors. Each back-end processor, after completing its processing of information associated with a call, routes the call using routing tables over the internal network 41 (FIG. 4) to an appropriate BTS for handling that call or by direct connection to the call processing equipment.

As shown in FIG. 4, a receive only antenna 50 and a receive and transmit antenna 52 at a tower site are served by an RF front end processor and router 54 that is located near the tower or other structure that supports the antennas. In some examples, only one front-end processor would be required at a given tower site to serve a variety of frequency bands. This could be accomplished by replacing conventional narrower band antennas with wideband antennas. A bank of amplifiers could be used with different frequency ranges being handled by different ones of the amplifiers. In other examples, multiple send and receive antennas could be employed. Smart antennas could also be used. There could be a wide variety of other antenna configurations; the arrangement shown in FIG. 4 is only one example. In other examples, the antennas could be band or customer specific and be attached to dedicated power amplifiers. The processor and router 54 includes an RF processor 56 (examples of which are commercially available) and a baseband processor 58. The RF processor modulates and demodulates the baseband bitstreams associated with calls on RF signals that are transmitted and received through the antennas. The baseband processor 58 processes the baseband call streams that are provided to and received from the RF processor and embeds and removes digital information in and from packets that are passed back and forth to and from a network physical interface 60. The network physical interface is coupled to the network 37 shown in FIG. 2, which carries the packets back and forth between the baseband processor and back-end processors.

In the RF processor 56, RF signals received on both of the antennas are passed through a low-noise amplifier 62 to produce a pair of amplified RF signals 64, 65 (associated with the respective antennas). The amplified RF signals are fed to an RF receiver 66, which conditions the RF signals for use by an analog-to-digital converter 68. The digitized signals at the output of the converter are passed through a digital down converter 70. The digital down converter demodulates the digital versions of the RF signals to recover the baseband call bitstreams. The digital baseband call streams are then passed through a filtering and diversity element 72, which, among other things, combines the received signals from the two antennas, taking advantage of their differences to produce a better baseband digital stream 74. The resulting stream is passed through a baseband interface 76 for delivery to the baseband processor. The baseband call stream is a stream of un-discriminated bits that represent the symbols of content and control that are carried in the call.

Considering the reverse process followed within processor 56, outgoing digital baseband bitstreams 78a are received at the baseband interface 76 and passed to a digital up converter 80. The digital up converter forms digital samples corresponding to an RF signal at the appropriate frequency modulated by the baseband stream. The up converter samples are passed through a digital-to-analog converter 82. The resulting analog signal is delivered to an RF transmitter 84, which conditions the signal for transmission. The conditioned signal is fed through a master power control amplifier 86 to the antenna 52. The master power control amplifier 86 regulates the power level of the signal delivered to the antenna in a conventional way.

The bits of the digital baseband streams 74, 78a carry symbols that contain the content of the call and control information in accordance with the associated protocol. The baseband processor 58 includes a symbol demodulator 81 that converts the call stream 74 to a stream of symbols 83 that represent the content and control information. The stream of symbols is then subjected to a partial decoding 85 that, without actually decoding the symbols, identifies portions of the stream as relating either to content or control and then delivers portions of the bitstream that relate to content 88 to a content decoding element 92 and portions of the bitstream that relate to control 90 to a control decoding element 94. One way to perform the partial symbol decoding 85 uses pattern matching to compare patterns of bits in the incoming bitstream with known patterns of bits that represent content and known patterns of bits that represent control. Other partial decoding approaches are also possible.

The content decoding element 92 accepts the portions of the stream that relate to content and decodes them into symbols that contain call content in a format that accords with the sampled digital voice or data stream. The control decoding element 94 accepts the portions of the stream that relate to control and decodes them into specific control instructions.

The content and control symbol streams 96, 98 that are produced by the content and control decoding elements 92, 94 are then assembled by a packetizing engine 100. In the packetizing engine, a content assembler 97 receives decoded content symbols and assembles them for inclusion in a packet. Also, in the packetizing engine 100, a control assembler 99 receives decoded control symbols and assembles them for inclusion in the packet. The assembler includes as many symbols as can fit within the frame size of that packet. A given packet could contain only content symbols, only control symbols, or both content and control symbols. The assembled control and content symbols for a packet are supplemented with a header that is assembled by a header assembler 101 to complete the packet 104. The header is generated based on characteristics of the control or content symbols in the packet and on information provided from a configuration store 102 together with network addressing information that enables a packet router to route the packet in the network 37. The network addressing information comes from the routing tables stored within the packet engine.

The configuration store contains configuration information associated with each provider, location, and protocol that may be used for each of the call streams being processed. For example, a content packet for a call could include the digital representation of the sampled voice stream and its header may include, for example, the provider code, the geocode of the location, the packet type (e.g., control packet versus content packet), the frequency range processed, and the air link type (e.g., IS-95, GSM) used for the transmission. The configuration store contains necessary information (e.g., the store might contain an entry: A/T/16245/GPRS/872.0/872.3/ in which A refers to the carrier (i.e. AT&T), T refers to the packet type (content), 16245 refers to the geocode, GPRS refers to the airlink type, 872.0 refers to the lower marker of the frequency channel processed, and 872.3 refers to the upper marker of the frequency channel processed) for the header creation and can be updated either on-site or by communication from a remote location either directly or through a network such as network 37. Packet headers may be shortened by various methods.

In assembling the packet header, the packet engine uncovers the network ID contained in the control symbols of the terminal or network device that the terminal device uses to identify the carrier and uses that ID to fetch a corresponding record from the configuration store. The engine knows the band assigned to the carrier and the band the call information was transmitted on. The engine references its internally stored geo code. The engine also knows from the call stream received and the assignment of that frequency channel what kind of airlink is in use. Together this knowledge provides enough information to create the header. The content packets and control packets are compressed in the baseband processor 58 by removing unnecessary or redundant information in the symbol decoder. The packetizing engine also compresses information by various methods such as not repeating known or predictable data. For example, where a packetized symbol is simply a repetition of an previously transmitted symbol such as a control stream alerting the terminal user that they have a call waiting, a repeat symbol message can be sent rather than sending the entire message. A routing engine 106 then processes each of the packets 104 in a typical fashion and routes them toward appropriate destinations through the network physical interface 60. For purposes of routing, the routing engine consults routing tables stored in the routing engine and sends the packet through network 37, based on the destination address contained in its header, towards an appropriate call processing facility as advertised in the network. For this purpose, each of the call processing facilities advertises its availability to process packets and identifies the carriers and protocols of the packets that it is capable of processing. The front end processor routing engine decides where to send the packet based on services that are advertised to be able to handle specifically packets of a certain carrier and a certain protocol and certain frequency. What is advertised are the services, status, addresses, and availability of the call processing facility. The advertised addresses are used in building and updating the routing table in the routing engine. As in other kinds of known networks, the front-end and back-end processors can create high-priority “virtual” connections between front-end and back-end processors on the network 37 and tear down the virtual connections as needed. Simlarly, back-end processors can de-advertise if the call processing facilities are busy or experience a failure. Then, if available, a secondary route or destination can be used,

Conversely, incoming packets received at the routing engine 106 from the network physical interface 60 are passed to an unpacketizing engine 108 which unpacks the header and the content symbols and control symbols from the packets. The content and control symbols are unpacked from the payload contained in the packet by removing the header information and stripping out the streams of symbols from the digital information contained in the packet.

The resulting content symbols and control symbols are delivered respectively to content and control decoders 110, 112. The content decoder 110 uses the content information to generate content symbols in accordance with the relevant protocol by reassembling the packets into symbol bitstreams, and in the same manner the control encoder uses the control information to generate content symbols in accordance with the relevant protocol. The resulting content and control symbols are delivered to symbol encoder 114 which combines them to produce a single stream 116 of symbols in the sequence that is appropriate to the protocol. The call stream is then modulated and subjected to filtering and pre-distortion processing 118 and is sent to the baseband interface 76 for transmission as explained earlier.

A feedback loop 120, 122, 124 ties the output of the filtering and pre-distortion element 118 to the master control power amplifier 86 to control the signal level of the transmission based on the quality of the radio frequency signal. The actual signal level is fed through an analog-to-digital converter 126 to provide the information necessary for the signal processing.

Referring to FIG. 5, an RF back end processor and router 130 includes a baseband processor 132, which is connected to a network physical interface 61, and an RF processor 134. The network interface is coupled to the network 37 shown in FIG. 3. The components of the baseband processor 132 are analogous to those for the RF processor of FIG. 4 except that they do not include the filtering and pre-distortion element 118.

The elements of the RF processor 134 are similar to those shown in FIG. 4. However, in FIG. 4, instead of being delivered to and from antennas, the up converted signal is communicated either in the digital domain back and forth to and from a digital physical interface 136 or back and forth to and from an analog (RF) physical interface 138. In the case of an analog interface 138, the RF signal is fed along paths similar to those in FIG. 4, except that there is only one signal being processed rather than the two antenna signals of FIG. 4, and there is no filtering and diversity element to combine multiple received signals. For the digital physical interface, the signals are passed back and forth through digital transmitter and receiver 140, 142 directly to and from the up and down converters.

The digital physical interface and the analog physical interface are interfaces to the network 41 of FIG. 3 and the modulated signals provided by those interfaces are processed either by conventional RF base station devices at the call processing facility (in the case of analog signals) or by RF-less base stations that can operate directly on either digitally sampled versions of the RF signal or, in other examples, directly on the baseband signal. Although the example of FIG. 3 includes a local area network to interconnect the call processing devices, in other examples the connections could be dedicated lines, wide area networks, or other kinds of interconnection arrangements.

For call information coming from the base stations and destined for the tower sites, the back-end processor forms packets and routes them back to the appropriate tower using the virtual connection that was set up upon the initiation of the call. For example a call coming into the call processing facility from the PSTN would use the standard methods employed in the wireless telephony system to determine the location of the terminal device assigned to that number. The base station assigned to that location would then communicate with the remote antenna site by sending the appropriate symbols to the router for delivery to the remote site.

An example of a template for packets that are passed through the network physical interfaces 60, 61 between the front-end processors and the back-end processors is shown in FIG. 6.

The payload 150 of the packet includes wireless spectrum routing (WSR) control symbols 153 (which are handled by the control assembler and control unpacker of FIGS. 3 and 4) and WSR content symbols 151 (which are also handled by the content assembler and the content unpacker of FIGS. 3 and 4). The payload is supplemented with header information that includes a spectrum routing protocol (SRP) header 152. If the packets are being routed onto an Internet Protocol (IP) over Ethernet network, for example, they would also include an Internet protocol (IP) header 154 and an Ethernet header 156 for routing purposes.

In the example shown in FIG. 6, the SRP header is designed to enable packets for each call to be routed by the routing engine to a base station in the call processing facility that is associated with the correct carrier and the appropriate protocol. The SRP header includes the following fields. A source SRP NetID field 164 includes a service provider ID 166 (for example, an identifier for Verizon, the service provider that is carrying the call, which is derived from the control symbols in the call signal), a spectrum range 168 that identifies the allocated portion of the segment of the frequency band of the spectrum in which the communication is being carried (for example, 859-860.5 MHz, derived from the control symbols in the call signal), a geographic location field 170 that identifies the physical location of the antenna that is carrying the call (for example, a specific identification of the site), and a type field 169 (identifying the protocol, for example, GSM, which is derived from the call signal). The information needed to complete the fields of the source SRP NetID are derived by the packetizing engine 100 based on information available at the site, information derived from the control symbols being processed, and information stored in the configuration store.

An SRP sequence number field 172 in the SRP header indicates the packet's relative position within a sequence of packets associated with a single session (a call, for example). The sequence number is controlled by the packetizing engine. An SRP Ack number field 174 is used in conjunction with the sequence number and contains the next expected sequence number in the reverse direction. An SRP window field 180 indicates a size of the frame in which the packet resides and an SRP checksum field 182 provides an error check on the bits in the SRP header.

The Ethernet header 156 and IP header 154 contain conventional header information based on known header definitions for Ethernet and IP protocols.

The IP and Ethernet headers, if they exist, enable routing of packets through the IP network to destination nodes in the usual way. The SRP headers enable routing of the packets to call processing facilities, and in particular to base stations (and base station controllers) in those facilities, that are suitable for handling calls of a particular carrier and of a particular protocol and that are the eventual destinations of the packet. For example, the routing engine would implement a route for a packet with header information that indicates it is a Verizon CDMA IS-95b voice call from a site #345 in BTA# 126 and carried at 1926.5 to 1928 MHz to a call processing facility that was advertised on the network as capable of processing that call. A route would then be established as a virtual connection for the duration of that call transaction and the content and control packets would follow that route.

The arrangements described above enable effective allocation and load sharing of the processing load for calls, permit sharing of the cost of acquiring and operating call processing facilities, support more efficient sharing of spectrum, and achieve a variety of other benefits. In conventional systems, each tower site contains all of the call processing capability and RF power necessary to handle the peak hour usage anticipated for that site. Not all sites have the same peak hour usage. Thus, for example, if an amount of call processing power X is needed to handle an anticipated peak hour volume of calls Y at a single site, and if there are three such sites, then in a distributed processing environment (in which call processing is focused in each of the tower sites), each of the sites would need its X amount of processing power to handle Y calls. Thus an aggregate processing power of 3 X would be needed to assure the ability to handle Y calls. This is true because, in a conventional system, the processing capacity cannot be moved from site to site at any time even though some calls will be expected to migrate from one site to another as users shift their locations. Total call volume in any given hour across all sites may be much less than 3 Y because the peak hour rates may not coincide for all sites. Often the maximum total call volume may only be on the order of 1.5 Y in the example, because callers move, for example, from downtown to travel corridor to suburb in a migratory pattern. In the example, with centralized processing and the total capacity of calls never being greater than 1.5 Y, the aggregate call processing capacity required to handle the maximum peak load of the three-site system is reduced by 50%. Thus, by routing the calls as packets of partially processed content and control symbols, rather than as base station-processed calls, virtual circuits can be set up between many tower sites and one or more commonly shared call processing facilities. Processing load then can be shared across many sites and processing load can be averaged across many geographies.

Also, by centralizing call processing facilities, operations, maintenance, and upgrade costs are reduced relative to the large cost of maintaining, operating, and upgrading hundreds of geographically separated network elements. Upgrading provides a particularly notable example. In a conventional distributed call processing environment, if a new type of processing card is needed, to the card will have to be replaced in every base station at every tower site. In a centralized call processing system, the central site can be upgraded without the necessity for site visits. Likewise, new services and networks can be deployed by simply adding processing at the central site without the necessity of deploying to each site. To the extent that reprogramming of the configuration store of the front-end processors would be necessary in order to accommodate changes in the identities of carriers, protocols, or segments of spectrum, they could be done by downloading from a central location rather than requiring a site visit.

Network reliability can also be enhanced by having redundant facilities (back-end processors, base stations at the call processing facility, for example) serve as back up processors to elements that are in a busy or failed state.

Another advantage is the ability for carriers to share or arbitrage spectrum. Carriers, or even third parties who are not carriers, can operate their own call processing facilities, and traffic from the same frequency range can be automatically routed to another call processing facility associated with the carrier of the terminal that is originating or terminating the call.

Also, translations from one type of signaling technology to another are possible in which one terminal (e.g., phone) could be sending and receiving one type of signal (such as IS-136) and the front-end and back-end processors can transform and repackage the signal into a different type technology (such as GSM). This transformation could be used in emergency situations, for example, in which a public emergency response agency has one type of radio and another agency has another.

The techniques described above may be implemented in hardware or software or combinations of hardware and software. The hardware may be existing commercially available or custom-configured devices in which software modifications have been made. The arrangement of hardware devices and the combinations of hardware devices that may be used to perform the functions and combinations of functions described above can be varied so that, in some cases, functions may be divided between a few or many hardware units, and in other cases, functions may be combined and organized within more comprehensive hardware devices.

Although examples of implementations have been described above, other implementations are also within the scope of the following claims.

For example, calls could be routed from the tower sites to the call processing facilities without using a packet network, for example, by using layer one switching techniques.

Wireless communication signals can also be converted in the call processing facility to protocols other than the protocols to which they originally conformed. Then the signals can be forwarded through a public switched network to their destinations. The conversion can be done based on knowledge of the protocol format of the destination.

1. A method comprising
receiving a wireless communication signal from an antenna at a site,
forming packets that contain communication information derived from the wireless communication signal, each of the packets containing routing information sufficient to enable routing of the packet to a processor capable of providing communication processing services suitable for the wireless communication signal, and
routing the packets through a network to a processor not located at the site and that is capable of providing communication processing services suitable for the wireless signal.

2. A method comprising
receiving a wireless communication signal at a communication processing facility,
forming packets that contain communication information derived from the wireless communication signal, each of the packets containing routing information sufficient to enable routing of the packet to a site suitable to transmit the communication information wirelessly to a mobile station, and
routing the packets through a network to a site not located at the communication processing facility and that is suitable to transmit the communication information to the mobile station.

3. The method of claim 1 or 2 in which the communication signal comprises a telephone call signal.

4. The method of claim 1 or 2 in which forming the packets includes embedding routing information in a header of each of at least some of the packets.’

5. The method of claim 4 in which the routing information includes an identification of a carrier associated with the wireless communication signal.

6. The method of claim 4 in which the routing information includes an identification of a protocol used for the wireless communication signal.

7. The method of claim 4 in which the routing information includes an identification of a spectrum range used for the wireless communication signal.

8. The method of claim 4 in which the routing information includes an identification of a location of the site.

9. The method of claim 1 or 2 in which the packets contain content information and control information associated with the wireless communication signal.

10. The method of claim 9 in which the control information is compressed before routing.

11. The method of claim 9 in which the content information is compressed before routing.

12. The method of claim 9 in which the control information is usable by the processor to provide call processing services with respect to the call signal.

13. The method of claim 1 or 2 in which the packets are formed and routed without fully decoding the wireless communication signal.

14. The method of claim 1 or 2 also including partially decoding symbols carried in the wireless communication signal to derive at least some of the identification information.

15. The method of claim 1 also including
receiving other wireless communication signals at the site,
forming other packets that contain communication information derived from the other wireless communication signals, each of the packets containing routing information sufficient to enable routing of the packet to a processor capable of providing communication processing services suitable for the wireless communication signal, and
routing the other packets through a network to processors not located at the site and that are suitable to provide communication processing services suitable for the wireless signals.

16. The method of claim 2 also including
receiving other wireless communication signals at the communication processing facility,
forming other packets that contain communication information derived from the other wireless communication signals, each of the packets containing routing information sufficient to enable routing of the packet to a site suitable to transmit the communication information wirelessly to a mobile station, and
routing the other packets through a network to sites not located at the communication processing facility and that are suitable to transmit the communication information to the mobile stations.

17. The method of claim 1 also including
receiving other wireless communication signals at other sites,
forming other packets that contain communication information derived from the other wireless communication signals, each of the packets containing routing information sufficient to enable routing of the packet to a processor capable of providing communication processing services suitable for the wireless communication signal, and
routing the other packets through a network to processors not located at the sites and that are suitable to provide communication processing services suitable for the wireless signals.

18. The method of claim 2 also including
receiving other wireless communication signals at other communication processing facilities,
forming packets that contain communication information derived from the other wireless communication signals, each of the packets containing routing information sufficient to enable routing of the packets to sites suitable to transmit the communication information wirelessly to mobile stations, and
routing the packets through a network to sites not located at the communication processing facilities and that are suitable to transmit the communication information to the mobile station.

19. A method comprising
receiving wireless communication signals at geographically distributed sites, and
routing the wireless communication signals from the sites through a packet-based or switched communication network to processors configured to perform communication processing operations on the wireless communication signals.

20. A method comprising
receiving wireless communication signals at communication processing facilities, and
routing the wireless communication signals from the communication processing facilities through a packet-based or switched communication network to sites capable of transmitting the wireless communication signals wirelessly to mobile stations.

21. The method of claim 19 or 20 in which the communication signals comprises telephone call signals.

22. The method of claim 19 or 20 in which wireless communication signals are routed based on identification information.

23. The method of claim 22 in which the identification information includes an identification of a carrier associated with the wireless communication signal.

24. The method of claim 22 in which the identification information includes an identification of a protocol used for the wireless communication signal.

25. The method of claim 22 in which the identification information includes an identification of a spectrum range used for the wireless communication signal.

26. The method of claim 22 in which the identification information includes an identification of a location of the site.

27. The method of claim 19 or 20 in which the signals contain content information and control information associated with the wireless communication signal.

28. The method of claim 27 in which the control information is compressed before routing.

29. The method of claim 27 in which the content information is compressed before routing.

30. The method of claim 27 in which the control information is usable by the processor to provide call processing services with respect to the call signal.

31. The method of claim 19 or 20 in which the wireless communication signals are routed without fully decoding the wireless communication signal.

32. The method of claim 19 or 20 also including partially decoding symbols carried in the wireless communication signal to derive at least some of the identification information.

33. A method comprising
receiving wireless communication signals at geographically distributed sites, and
performing base station processing on the wireless communication signals in at least one location remote from the sites.

34. The method of claim 33 also including
performing base station control functions with respect to the wireless communication signals in at least one location remote from the sites.

35. The method of claim 33 in which the base station processing is performed by devices that are interconnected by a network.

36. The method of claim 35 in which processing of wireless communication calls is allocated among the devices to balance load.

37. A method comprising
receiving wireless communication signals at sites, each of the wireless communication signals conforming to a predetermined wireless communication protocol.
routing the wireless communication signals to devices separated from the sites for wireless communication processing, and
forwarding the wireless communication signals through a public switched network to destinations,
at least some of the wireless communication signals being converted by the devices to protocols other than the predetermined protocols prior to being forwarded to destinations.

38. A method comprising
receiving wireless communication signals at a site,
without performing complete base station call processing on the received signals at the site, sending the wireless communication signals to other locations for call processing.

39. A method comprising
receiving wireless communication signals at a site,
performing partial processing on each of the signals including compression and determination of a carrier with which the signal is associated, and
routing each of the signals, after partial processing, to a location separate from the site for communication signal processing in accordance with the determined carrier.

40. A medium bearing a data structure capable of invoking routing functions of a network comprising
a network packet including information associated with content of a wireless communication signal,
the packet also including routing information sufficient to enable the packet to be routed to a device capable of processing the wireless communication signal.

41. The medium of claim 40 in which the routing information includes an identification of a geographic location of a site at which the wireless communication system is being handled.

42. The medium of claim 40 in which the routing information includes an identification of a service provider that is providing service with respect to the communication signal.

43. The medium of claim 40 in which the routing information includes an identification of a spectrum range associated with the communication signal.

44. Apparatus comprising
an interface to a packet network that serves sites at which wireless communication signals are handled,
communication processing equipment configured to process wireless communication signals, and
a mechanism to share processing of the wireless communication signals among available equipment of wireless communication processing facilities.

45. The apparatus of claim 44 in which the mechanism comprises a second network.

46. The apparatus of claim 44 in which the mechanism comprises load sharing among multiple devices of the call processing facilities.

47. A method comprising
sending from a site to a wireless communication processing location that is separate from the site, information about wireless transmission services that are available at the site,
accepting at the site, wireless communication signals from the wireless communication processing location, and
performing wireless transmission services at the site with respect to the signals.

48. A method comprising
at a site that handles wireless communication signals for mobile stations, down converting incoming wireless communication signals to baseband signals, and
communicating the baseband signals to a location separate from the site for performance of call processing.
